(19) United States
(12) Patent Application Publication
(10) Pub. No.: US 2020/0340088 A1
(43) Pub. Date: Oct. 29, 2020

(54) LAMINATED CORE AND METHOD FOR THE PRODUCTION OF A HIGH PERMEABILITY SOFT MAGNETIC ALLOY

(71) Applicant: Vacuumschmelze GmbH & Co. KG, Hanau (DE)

(72) Inventors: Jan Frederik FOHR, Rödermark (DE); Johannes TENBRINK, Mömbris (DE); Niklas VOLBERS, Bruchköbel (DE)

(21) Appl. No.: 16/849,335

(22) Filed: Apr. 15, 2020

(30) Foreign Application Priority Data
Apr. 26, 2019 (DE) 10 2019 110 872.1

(51) Int. Cl. C22C 38/52; C21D 8/02; C21D 9/46; C21D 9/00; H02K 1/02; H02K 1/06; C22C 38/46; C22C 38/44; C22C 38/02; C22C 38/04; C22C 38/06; C22C 38/00

(52) U.S. Cl. CPC C22C 38/52; C22C 38/58; C21D 8/0226; C21D 9/46; C21D 9/0081; H02K 1/02; H02K 1/06; C22C 38/46; C22C 38/44; C22C 38/02; C22C 38/04; C22C 38/06; C22C 38/002; C22C 2202/02; C21D 8/0236

(57) ABSTRACT

A soft magnetic alloy is provided. The alloy consists essentially of 5 wt %≤Co≤25 wt %, 0.3 wt %≤V≤5.0 wt %, 0 wt %≤Cr≤3.0 wt %, 0 wt %≤Si≤3.0 wt %, 0 wt %≤Mn≤3.0 wt %, 0 wt %≤Al≤3.0 wt %, 0 wt %≤Ta≤0.5 wt %, 0 wt %≤Ni≤0.5 wt %, 0 wt %≤Mo≤0.5 wt %, 0 wt %≤Cu≤0.2 wt %, 0 wt %≤Nb≤0.25 wt % and up to 0.2 wt % impurities.

This U.S. patent application claims the benefit of DE Patent Application No. 10 2019 110 872.1, filed on Apr. 26, 2019, the entire contents of which are incorporated herein by reference for all purposes.

### BACKGROUND

### 1. Technical Field

The present invention relates to a laminated core and a method for the production of a soft magnetic alloy, in particular a high permeability soft magnetic alloy and a laminated core.

### 2. Related Art

Non-grain-oriented electrical steel with approx. 3 wt % silicon (SiFe) is the most common crystalline soft magnetic material used in laminated cores in electric machines. As the electric-powered vehicle sector progresses, more efficient materials that perform better than SiFe are needed. In addition to sufficiently high electrical resistance, this means that a higher level of induction, in particular, is desirable to provide high torques and/or compact components.

Even more efficient materials are desirable for use in sectors such as the automotive industry and electric-powered vehicles in order to increase power density. Soft magnetic cobalt-iron (CoFe) alloys are also used in electric machines due to their extremely high saturation induction. Commercially available CoFe alloys typically have a composition of 49 wt % Fe, 49 wt % Co and 2 % V. In compositions of this type both a saturation induction of approx. 2.35 T and a high electrical resistance of 0.4 μΩm are achieved. However, it is also desirable to reduce the material and production costs of CoFe alloys, which result from the high Co content, additional manufacturing steps and the scrap content, for example.

The object of the present invention is therefore to provide an FeCo alloy that both has lower material costs and is easy to work in order to reduce the production costs of the alloy, up to and including laminated cores, and at the same time to achieve high power density.

### SUMMARY

According to the invention, a method for the production of a soft magnetic alloy, in particular a high permeability soft magnetic FeCo alloy, is provided. Initially, a to preliminary product (precursor product) is provided that consists essentially of:

| | | |
|---|---|---|
| 5 wt % | ≤Co | ≤25 wt % |
| 0.3 wt % | ≤V | ≤5.0 wt % |
| 0 wt % | ≤Cr | ≤3.0 wt % |
| 0 wt % | ≤Si | ≤3.0 wt % |
| 0 wt % | ≤Mn | ≤3.0 wt % |
| 0 wt % | ≤Al | ≤3.0 wt % |
| 0 wt % | ≤Ta | ≤0.5 wt % |
| 0 wt % | ≤Ni | ≤0.5 wt % |
| 0 wt % | ≤Mo | ≤0.5 wt % |
| 0 wt % | ≤Cu | ≤0.2 wt % |
| 0 wt % | ≤Nb | ≤0.25 wt % |
| 0 wt % | ≤Ti | ≤0.05 wt % |
| 0 wt % | ≤Ce | ≤0.05 wt % |
| 0 wt % | ≤Ca | ≤0.05 wt % |
| 0 wt % | ≤Mg | ≤0.05 wt % |
| 0 wt % | ≤C | ≤0.02 wt % |
| 0 wt % | ≤Zr | ≤0.1 wt % |
| 0 wt % | ≤O | ≤0.025 wt % |
| 0 wt % | ≤S | ≤0.015 wt % |

residual iron, wherein Cr+Si+Al+Mn≤3.0 wt %, and up to 0.2 wt % of other impurities due to melting. Other impurities include, for example, B, P, N, W, Hf, Y, Re, Sc, Be and other lanthanides other than Ce.

The preliminary product has a phase transition from a BCC phase region to a mixed BCC/FCC region to an FCC phase region, as the temperature rises the phase transition between the BCC phase region and the mixed BCC/FCC region taking place at a first transition temperature T_{Ü1} and, as the temperature continues to rise, the transition between the mixed BCC/FCC region and the FCC phase region taking place at a second transition temperature T_{Ü2}, where T_{Ü2}>T_{Ü1} and the difference T_{Ü2}−T_{Ü1} is less than 45K, preferably less than 25K.

The preliminary product is subjected to the following heat treatment:
the heating of the preliminary product to a temperature T₁, followed by
the heat treatment of the preliminary product at temperature T₁ for a period t₁, followed by cooling from T₁ to room temperature, or

the preliminary product is subjected to the following heat treatment:
the heating of the preliminary product to a temperature T₁, followed by
the heat treatment of the preliminary product at temperature T₁ for a period t₁, followed by
the cooling of the preliminary product to a temperature T₂, followed by
the heat treatment of the preliminary product at temperature T₂ for a period t₂, followed by
the cooling of the preliminary product from T₂ to room temperature,
where T₁>T₂, T₁ is above T_{Ü2} and T₂ is below T_{Ü1}, where 920° C.≤T₁<Tₘ, 700° C.≤T₂≤1050° C., and Tₘ is the solidus temperature.

For both methods the heating rate over at least the temperature range from T_{Ü1} to T_{Ü2} is 1 K/h to 100 K/h, preferably 10 K/h to 50 K/h, and the cooling rate over at least the temperature range from T_{Ü2} to T_{AÜ1} is 1 K/h to 100 K/h, preferably 10 K/h to 50 K/h.

Conventionally, the preliminary product is heat treated in a hydrogen-containing atmosphere or in an inert gas, preferably in dry hydrogen.

In some embodiments the preliminary product has a cold-rolled texture or a fibre texture prior to the start of the heat treatment.

According to the invention, the preliminary product is thus heated and cooled slowly through the transitions between the BCC phase region and the mixed BCC/FCC region and between the mixed BCC/FCC region and the FCC phase region. It has been established that the heating rate exerts an influence on the shape of the preliminary product. In particular, the flatness of preliminary products in the form of sheets, including stacked sheets, following heat treatment is achieved if the heating rate is 1 K/h to 100 K/h, preferably 4 K/h to 100 K/h, preferably 10 K/h to 50 K/h, in particular at least over the temperature range from T_{Ü1} to T_{Ü2}. The same applies to the cooling rate between T_{Ü2} and T_{Ü1}, where the cooling rate is 1 K/h to 100 K/h, preferably 4 K/h to 100 K/h, preferably 10 K/h to 50 K/h, in particular at least over the temperature range from T_{Ü2} to T_{Ü1}.

It has been found that heating or cooling sheets too quickly results in wavy sheets that also exhibit a type of plastic deformation within the sheets. This observation may be explained by the phase transformation of the alloy. When passing through the two-phase region, the body-centred α-phase (BCC) transforms into the more closely packed face-centred γ-phase (FCC) as it is heated. This leads to a contraction of the sheets. A retransformation, during which the original geometry is ideally restored, then takes place during cooling. In the method according to the invention the alloy is twice subjected to a phase transformation. It can be assumed that the deformation observed is due to the increase in volume during transformation and retransformation. The slower heating and cooling rates according to the invention make it possible to prevent avoid the formation of this waviness and the deformation.

Heating and cooling rates of 20 K/h and 10 K/h can be used. Appropriate rates can be chosen according to the shape of the preliminary product. For example, heating and cooling rates below 50 K/h can be used for stacks of 50 sheets, while heating and cooling rates below 35 K/h can be used for stacks of 100 sheets.

The cooling rate over at least the temperature range from T_{Ü2} to T_{Ü1} may also be 1 K/h to 100 K/h, preferably 4 K/h to 50 K/h, preferably 10 K/h to 50 K/h, in order to maintain the flatness of the sheets. A slower cooling rate can also be used to improve soft magnetic properties, in particular induction B.

In one embodiment the heating rate and/or the cooling rate are set as desired over a larger temperature range. In one embodiment the heating rate over at least the temperature range from 900° C. to T₁ is 1 K/h to 100 K/h, preferably 4 K/h to 100 K/h, preferably 10 K/h to 50 K/h.

In one embodiment the cooling rate over at least the temperature range from T₁ to 900° C. is 1 K/h to 100 K/h, preferably 4 K/h to 50 K/h, preferably 10 K/h to 50 K/h.

In one embodiment the temperature T₁ of the heat treatment in the FCC phase is region is defined in greater detail such that T₁ is between T_{Ü2} and (T_{Ü2}+100° C.), i.e. the temperature T₁ is only slighter higher than the transition temperature T_{Ü2} from the two-phase FCC/BCC region to the FCC region. In further embodiments T₁ is between (T_{Ü2}+2° C.) and (T_{Ü2}+100° C.) or between (T_{Ü2}+2° C.) and (T_{Ü2}+50° C.). Temperatures in this range can be used to improve soft magnetic properties, e.g. to achieve higher induction and lower coercive field strength.

In one embodiment the preliminary product is weighted down by an additional weight and the preliminary product undergoes heat treatment together with the weight. This weight can be at least 20%, preferably at least 50%, of the weight of the preliminary product.

If the preliminary product takes the form of a sheet, it may deform during heat treatment even at the heating rate and cooling rate specified, producing a sheet that is no longer flat, but wavy. This is undesirable in some applications such as laminated cores. The additional weight can be used to prevent the deformation of the preliminary product and to maintain the flatness of the sheet.

The preliminary product may take the form of a plurality of stacked sheets or one or more laminated cores. In this embodiment the weight, if used, may be positioned on the stack or on the uppermost sheet in the stack during heat treatment.

In some embodiments the preliminary product takes the form of a plurality of stacked sheets that are each coated with an electrically insulated coating. In this embodiment the weight, if used, can be positioned on the stack or on the uppermost sheet of the stack during heat treatment.

In one embodiment the preliminary product is further coated with an oxide layer for electrical insulation. This embodiment may, for example, be used where the preliminary product is used in a laminated core. The preliminary product may, for example, be coated with a layer of magnesium methylate or zirconium propylate that transforms into an insulating oxide during heat treatment.

The preliminary product can also be heat treated in an atmosphere containing hydrogen or water vapour to form the electrically insulating layer. This targeted oxidation can be carried out in a separate targeted oxidation heat treatment process after the heat treatment that sets the magnetic properties.

In one embodiment sections of sheet stamped, laser cut or electrical discharge machined from the preliminary product are further subjected to final annealing, after which the individual annealed sheets are stuck together by means of an insulating adhesive to form a laminated core, or the individual annealed sheets are surface oxidised to form an insulating layer and then stuck, welded or laser welded together to form the laminated core, or the individual annealed sheets are coated with an inorganic-organic hybrid coating such as Remisol-C5, for example, and then further processed to form the laminated core.

Following heat treatment the preliminary product may be subjected to further heat treatment in an atmosphere containing oxygen or water vapour. This additional heat treatment may be used to form the insulating layer or to increase the thickness of an insulating layer already present on the preliminary product or sheets.

Following heat treatment at least one laminated core can be produced from the stacked sheets by means of electrical discharge machining, laser cutting or water jet cutting. As a result, in this embodiment during heat treatment the sheets do not yet have their final shape and may be rectangular.

In one embodiment the sheets are first cut to length from a strip, stacked and heat treated as a stack. Following heat treatment, the plurality of sheets can be stuck together by means of an insulating adhesive, or surface oxidised to create an insulating layer and then stuck or laser-welded together, or coated with an inorganic-organic hybrid coating. This stack or laminate is then further processed to form the laminated core. A laminated core with an outer contour for use in a stator or an rotor may, for example, be cut from the stack or laminate by means of electrical discharge machining.

Further heat treatment parameters designed to further improve the soft magnetic properties and/or the shape of the preliminary product are defined in greater detail in further embodiments.

In one embodiment 960° C.≤T₁<Tₘ.

In one embodiment the preliminary product is heat treated for a period of over 15 minutes above T_{Ü2} and then cooled to T₂.

The period t₁ at temperature T₁ may be 15 minutes≤t₁₂≤20 hours.

The period t₂ at temperature T₂ may be 30 minutes≤t₂≤20 hours.

In one embodiment the preliminary product is cooled at least from T₁ to room temperature and then heated from room temperature to T₂. The heat treatment at T₂ may be carried out as a separate heat treatment process at a later point.

Where annealing at T₁ is followed by cooling to room temperature, subsequent annealing can then advantageously be carried out at T₂. This improves, in particular, the soft magnetic parameters of permeability, which increases, H_{c}, which decreases, and hysteresis losses, which decrease. In contrast, the effect of this subsequent annealing on induction values is rather low. Alternatively, the temperature may be to held at T₂ during the cooling phase.

In one embodiment the preliminary product is heat treated at T₁ fora period t₁, where 15 minutes≤t₁≤20 hours, and then cooled from T₁ to T₂. In one embodiment the preliminary product is cooled from T₁ to T₂, heat treated at T₂ for a period t₂, where 30 minutes≤t₂≤20 hours, and then cooled from T₂ to room temperature.

In embodiments in which the preliminary product is cooled from T₁ to room temperature, the preliminary product can then be heated up from room temperature to T₂ and heat treated at T₂ according to one of the embodiments described herein.

As the alloy has no order-disorder transition owing to its low Co content, no quenching is carried out over the temperature range from 800° C. to 600° C. The cooling rate from 800° C. to 600° C. may, for example, be between 100° C./h and 500° C./h. However, a slower cooling rate may, in principle, also be chosen. The aforementioned cooling rates can also quite easily be applied until room temperature is reached.

According to the invention the cooling rate over at least the temperature range from T_{Ü2} to T_{Ü1} is therefore 1 K/h to 100 K/h, preferably 4 K/h to 50 K/h, preferably 10 K/h to 50 K/h. A cooling rate of 1 K/h to 100 K/h, preferably 4 K/h to 50 K/h, preferably 10 K/h to 50 K/h over the temperature range from T₁ to 900° C. or T₁ to T₂ can also be used.

The cooling rate from T₂ to room temperature has less influence on magnetic properties and the preliminary product can therefore be cooled from T₂ to room temperature at a rate of 10° C./h to 50,000° C./h, preferably 100° C./h to 1000° C./h.

In a further alternative embodiment the preliminary product is cooled from T₁ to room temperature at a cooling rate of 4 K/h to 50 K/h. In embodiments with slow cooling from T₁ to room temperature, e.g. a cooling rate of less than 100 K/h, preferably less than 50 K/h, it is also possible to dispense with subsequent heat treatment at temperature T₂.

Following heat treatment the preliminary product, that is the soft magnetic alloy that is produced from the preliminary product may have:
a maximum permeability μₘₐₓ≥5,000 and/or an electrical resistance ρ≥0.25 μΩm, hysteresis losses P_{Hys}≤0.07 J/kg at an amplitude of 1.5 T and/or a coercive is field strength H_{c} of ≤0.7 A/cm and/or an induction B≥1.90 T at 100 A/cm, or
a maximum permeability μₘₐₓ≥10,000 and/or an electrical resistance ρ≥0.25 μΩm and/or hysteresis losses P_{Hys}≤0.06 J/kg at an amplitude of 1.5 T and/or a coercive field strength H_{c} of ≤0.6 A/cm and an induction B≥1.95 T at 100 A/cm, or
a maximum permeability μₘₐₓ≥12,000, preferably μₘₐₓ≥17,000, and/or an electrical resistance ρ≥0,30 μΩm and/or hysteresis losses P_{Hys}≤0.05 J/kg at an amplitude of 1.5 T and/or a coercive field strength H_{c} of ≤0.5 A/cm, preferably a coercive field strength H_{c} of ≤0.4 A/cm, preferably a coercive field strength H_{c} of ≤0.3 A/cm, and/or an induction B≥2.00 Tat 100 A/cm.

The hysteresis losses P_{Hys} are determined from the re-magnetisation losses P at an amplitude of induction of 1.5 T across the y-axis intercept in a plot P/f over the frequency f by linear regression. The linear regression is carried out using at least 8 measured values distributed approximately evenly over a frequency range of 50 Hz to 1 kHz (e.g. at 50, 100, 200, 300, 400, 500, 600, 700, 800, 900 and 1000 Hz).

The preliminary product may be obtained from an ingot produced by vacuum induction melting, electroslag re-melting or vacuum arc re-melting from a molten mass. The molten mass consists essentially of:

| | | |
|---|---|---|
| 5 wt % | ≤Co | ≤25 wt % |
| 0.3 wt % | ≤V | ≤5.0 wt % |
| 0 wt % | ≤Cr | ≤3.0 wt % |
| 0 wt % | ≤Si | ≤3.0 wt % |
| 0 wt % | ≤Mn | ≤3.0 wt % |
| 0 wt % | ≤Al | ≤3.0 wt % |
| 0 wt % | ≤Ta | ≤0.5 wt % |
| 0 wt % | ≤Ni | ≤0.5 wt % |
| 0 wt % | ≤Mo | ≤0.5 wt % |
| 0 wt % | ≤Cu | ≤0.2 wt % |
| 0 wt % | ≤Nb | ≤0.25 wt % |
| 0 wt % | ≤Ti | ≤0.05 wt % |
| 0 wt % | ≤Ce | ≤0.05 wt % |
| 0 wt % | ≤Ca | ≤0.05 wt % |
| 0 wt % | ≤Mg | ≤0.05 wt % |
| 0 wt % | ≤C | ≤0.02 wt % |
| 0 wt % | ≤Zr | ≤0.1 wt % |
| 0 wt % | ≤O | ≤0.025 wt % |
| 0 wt % | ≤S | ≤0.015 wt % |

residual iron, wherein Cr+Si+Al+Mn≤3.0 wt %, and up to 0.2 wt % of other impurities. Other impurities include, for example, B, P, N, W, Hf, Y, Re, Sc, Be and other lanthanides other than Ce.

The molten mass is cast and solidified to form an ingot. The ingot is mechanically deformed to produce the preliminary product. This mechanical deformation may be carried out by hot rolling and/or forging and/or cold working.

In one embodiment the ingot is mechanically deformed by hot rolling at temperatures between 900° C. and 1300° C. to form a slab and then mechanically deformed to form a hot strip of thickness D₁.

In some embodiments the hot strip is then mechanically deformed by cold rolling to form a strip of thickness D₂, where 0.05 mm≤D₂≤1.0 mm and D₂<D₁.

In one embodiment a hot strip of thickness D₁ is initially produced by continuous casting and then mechanically deformed by cold rolling to form a strip of thickness D₂, where 0.05 mm≤D₂≤1.0 mm and D₂<D₁.

In one embodiment the degree of cold deformation by cold rolling is >40%, preferably to >80%, preferably >95%.

In one embodiment the ingot is mechanically deformed by hot rolling at temperatures of between 900° C. and 1300° C. to form a billet and then mechanically deformed by means of cold drawing to form a wire.

In one embodiment the degree of cold deformation by cold drawing is >40%, preferably >80%, preferably >95%.

In one embodiment following heat treatment the average grain size is at least 100 μm, preferably at least 200 μm, quite particularly preferably at least 250 μm, and the soft magnetic alloy has an induction B₁₀₀ (induction B at H=100 A/cm) of at least 1.90 T, preferably at least 1.95 T. An average grain size of at least 100 μm, 200 μm or 250 μm favours higher induction values and, above all, reduces coercive field strength H_{c} as grain size d_{K} increases.

Owing to the lower Co content, the raw material costs of the alloy according to the invention are less than those of an alloy based on 49 wt % Fe, 49 wt % Co, 2% V. The invention provides for an FeCo alloy with a maximum cobalt content of 25 per cent by weight that offers better soft magnetic properties, in particular appreciably higher permeability, than other FeCo alloys with a maximum cobalt content of 25 per cent by weight, e.g. existing commercially available FeCo alloys such as VACOFLUX 17, AFK 18 and HIPERCO 15. These existing commercially available alloys have a maximum permeability of less than 5000.

The alloy according to the invention has no adjustment in order and can therefore, s unlike alloys with over 30 wt % Co, be cold rolled without first undergoing a quenching process. Quenching is a difficult process to control, particularly where large quantities of materials are concerned, as it is hard to achieve sufficiently fast cooling rates and ordering may therefore take place, with the resulting embrittlement of the alloy. As a result, the lack of an order-disorder transition in the alloy according to the invention simplifies industrial-scale production.

Marked order-disorder transitions in alloys like that observed in CoFe alloys with a Co content greater than 30 wt % can be determined by means of differential scanning calorimetry (DSC) because they cause a peak in the DSC measurement. No such peak is observed in a DSC measurement carried out under the same conditions for the alloy according to the invention.

At the same time, however, in addition to the higher permeability level, this new alloy offers both significantly lower hysteresis losses than previously known commercially available alloys with Co contents of between 10 and 30 wt % and higher induction. The FeCo alloy according to the invention can also produced cost-effectively on an industrial scale.

Owing to its higher permeability, the alloy according to the invention can be used in applications such as rotors and stators in electric motors in order to reduce the size of the rotor or stator and thus of the electric motor, and/or to increase output. For example, it is possible to generate higher torque at the same physical size and/or weight, a solution that would prove advantageous if used in electrically-powered or hybrid motor vehicles.

In one embodiment, the alloy has a maximum permeability μₘₐₓ≥μₘₐₓ≥10,000, an electrical resistance ρ≥0.28 μΩm, hysteresis losses P_{Hys}≤0.055 J/kg at an amplitude of 1.5 T, a coercive field strength H_{c} of ≤0.5 A/cm and an induction B≥1.95 T at 100 A/cm. This combination of properties is particularly advantageous for use as or in a rotor or stator of an electric motor in order to reduce the size of the rotor or stator and thus of the electric motor, and/or to increase output, or to generate higher torque at the same physical size or weight.

The soft magnetic alloy can therefore be used in an electric machine, e.g. as or in a stator and/or rotor of an electric motor and/or generator, and/or in an transformer and/or in an electromagnetic actuator. It may be provided in the form of a sheet of thickness 0.5 mm to 0.05 mm, for example. A plurality of sheets made of the alloy can be stacked together to form a laminated core to be used as a stator or rotor.

The alloy according to the invention has an electrical resistance of at least 0.25 μΩm, preferably a minimum of 0.3 μΩm. Eddy current losses can be reduced to a lower is level by selecting a slightly smaller strip thickness.

The composition of the soft magnetic alloy is set out in greater detail in further embodiments, where 10 wt %≤Co≤20 wt %, preferably 15 wt %≤Co≤20 wt %, and 0.3 wt %≤V≤5.0 wt %, preferably 1.0 wt %≤V≤3.0 wt %, preferably 1.3 wt %≤V≤2.7 wt % and/or 0.1 wt %≤Cr+Si≤2.0 wt %, preferably 0.2 wt %≤Cr+Si≤1.0 wt %, preferably 0.25 wt %≤Cr+Si≤0.7 wt %.

In one embodiment, the sum is defined in greater detail, where 0.2 wt %≤Cr+Si+Al+Mn≤1.5 wt %, preferably 0.3 wt %≤Cr+Si+Al+Mn≤0.6 wt %.

The soft magnetic alloy may also contain silicon, where 0.1 wt %≤Si≤2.0 wt %, preferably 0.15 wt %≤Si≤1.0 wt %, preferably 0.2 wt %≤Si≤0.5 wt %.

Aluminium and silicon can be interchanged such that in one embodiment the total Si and Al (Si+Al) is 0 wt %≤(Si+Al)≤3.0 wt %.

The alloys according to the invention are almost carbon-free and contain at most 0.02 wt % carbon, preferably ≤0.01 wt % carbon. This maximum carbon content should be regarded as an unavoidable impurity.

In the alloys according to the invention calcium, beryllium and/or magnesium may be added in small amounts of up to 0.05 wt % only for deoxidisation and desulphurisation. Up to 0.05 wt % cerium or cerium Mischmetal can be added to achieve particularly good deoxidisation and desulphurisation.

The Curie temperature of the alloy may be taken into account when selecting the temperatures T₁ and/or T₂. For example, it is possible for T_{Ü1}>T_{c}, where T_{c} is the Curie temperature and T_{c}≥900° C. In one embodiment, T_{Ü1}>T₂>T_{c}.

In compositions in which there is a separation of the phase transition from BCC to the is two-phase BCC+FCC region and the Curie temperature T_{c}, there is a further temperature range with high self diffusion. This allows a larger BCC grain structure and thus better soft magnetic properties as a result of heat treatment in this region or cooling through this region. The separation of the two-phase region and the Curie temperature T_{c} also means that during cooling both the passage through the two-phase BCC/FCC region and the transition to the BCC-only phase region take place entirely in the paramagnetic state. The soft magnetic properties can be further improved by selecting temperature T₂ such that T_{Ü1}>T₂>T_{c}.

According to the invention, the improved magnetic properties can be achieved by heat treatment adapted to the composition as described below. It has been established, in particular, that ascertaining the phase transition temperatures for the selected compositions and determining the heat treatment temperatures and cooling rate in relation to the phase transition temperatures thus ascertained leads to improved magnetic properties. The fact that the alloys according to the invention with a cobalt content of at most 25 per cent by weight have no order-disorder transition, so that the manufacturing process does not require a quenching to avoid ordering and the embrittlement it causes, is also taken into account.

Conventionally, CoFe alloys are used in strip thicknesses ranging from 0.50 mm to a very thin 0.050 mm. In processing the strip, the material is conventionally hot rolled and then cold rolled to its final thickness. During cooling after hot rolling an embrittling adjustment in order takes place at approx. 730° C., and to ensure sufficient cold rollability special intermediate annealing followed by quenching is therefore required to suppress the adjustment in order. The alloy according to the invention requires no quenching since it has no order-disorder transition. This simplifies production.

To achieve magnetic properties, CoFe alloys are subjected to a final heat treatment also referred to as final magnetic annealing. The material is heated up to the annealing temperature, held at the annealing temperature for a certain length of time and then cooled at a defined speed. It is advantageous to carry out this final annealing at the highest possible temperatures and in a clean, dry hydrogen atmosphere since at high temperatures, firstly, the reduction of impurities by means of hydrogen is more efficient and, secondly, the grain structure becomes rougher and so soft magnetic properties such as coercive field strength and permeability improve.

In practice, the annealing temperature in the CoFe system has an upper limit since in the binary system a phase transition from the magnetic and ferritic BCC phase to the non-magnetic and austenitic FCC phase takes place at approx. 950° C. When elements are added to the alloy, a two-phase region in which both phases coexist occurs between the FCC phase and the BCC phase. The transition between the BCC phase and the mixed two-phase or BCC/FCC region occurs at a temperature T_{Ü1} and the transition between the two-phase region and the FCC phase occurs at a temperature T_{Ü2}, where T_{Ü2}>T_{Ü1}. The position and size of the two-phase region also depends on the nature and amount of the elements added to the alloy (additives)-making process. If annealing takes place in the two-phase region or in the FCC region, remnants of the FCC phase may impair the magnetic properties after cooling and incomplete retransformation. Even if retransformation is complete, the additional grain boundaries created still have an damaging effect since coercive field strength behaves inversely proportionately to grain diameter. Consequently, the known commercial available alloys with Co contents of approx. 20 wt % undergo final annealing at temperatures below the two-phase BCC+FCC region. As a result, the recommendation for AFK 18 is 3 h/850° C., and that for AFK 1 is 3 h/900° C., for example. The recommendation for VACOFLUX 17 is 10 h/850° C. At such low final annealing temperatures and owing to the relatively high magneto-crystalline anisotropy (K₁ approx. 45,000 J/m³ at 17 wt % Co), the potential for particularly good soft magnetic properties in these FeCo alloys is limited. With VACOFLUX 17 strip, for example, the maximum permeability that can be achieved at a typical coercive field strength of 1 A/cm is approx. 4,000 and its application is therefore limited, particularly in terms of motor and generator applications.

In contrast to these known final annealing processes, the composition according to the invention permits a heat treatment that produces better magnetic properties than the standard single-step annealing with furnace cooling used with FeCo alloys, irrespective of the temperature range in which the single-step annealing takes place. The additives are selected such that the lower limit of the two-phase region and the BCC/FCC phase transition are pushed upwards to allow annealing at high temperatures, e.g. above 925° C. in the BCC-only region. Annealing at such high temperatures is not conceivable with the FeCo alloys known to date.

Moreover, the width of the two-phase region, i.e. the difference between the lower transition temperature T_{Ü1} and the upper transition temperature T_{Ü2}, is kept as narrow as possible owing to the composition according to the invention. As a result, the advantages of high final annealing, i.e. the removal of potential magnetically unfavourable textures, the cleaning effect in H₂ and the growth of large grains, are maintained by final annealing above the two-phase region in conjunction with cooling through the two-phase region followed by a holding period or controlled cooling in the BCC-only region without the risk of magnetically damaging remnants of the FCC phase.

It has been found that compositions with a phase transition between the BCC-only region and the mixed BCC/FCC region exhibit appreciably improved magnetic properties at higher temperatures, e.g. above 925° C., and with a narrow two-phase region, e.g. of less than 45K. Compositions with this specific combination of phase diagram features are selected according to the invention and heat treated accordingly in order to achieve a high maximum permeability of greater than 5000 or greater than 10,000 or even greater than 15,000.

Vanadium has been identified as one of the most effective elements in an Fe—Co to alloy, increasing electrical resistance whilst at the same time pushing the two-phase region up to higher temperatures for alloys with a low Co content. With a lower Co content, vanadium is more efficient at increasing transition temperatures. With the Fe-17Co alloy, it is even possible to increase the transition temperatures above the value of the binary FeCo composition by adding approx. 2% vanadium.

In the binary Fe—Co system, the BCC/FCC phase transformation takes place at temperatures lower than the Curie temperature from approx. 15% cobalt. Since the FCC phase is paramagnetic, the magnetic phase transition is now determined by the BCC/FCC phase transformation rather than the Curie temperature. Sufficiently large amounts of vanadium push the BCC/FCC phase transformation over the Curie temperature T_{c}, making the paramagnetic BCC phase visible.

However, if the vanadium content is too high, the width of the mixed region is increased. These compositions have lower maximum permeability values even though the phase transition between the mixed BCC/FCC region and the BCC-only region takes place at higher temperatures. Consequently, it has been established that that the composition has an influence both on the temperatures at which the phase transitions take place and on the width of the mixed region, and should therefore be taken into account when selecting the composition. In order to achieve the highest permeability values, the heat treatment temperatures can be selected in relation to the temperatures at which the phase transitions for this composition take place.

It has thus been found that a more precise determination of the temperatures at which the phase transitions take place for a certain composition is advantageous when optimising the production process. These temperatures can be determined by s means of differential scanning calorimetry (DSC) measurements. The DSC measurement can be carried out with a sample mass of 50 mg and at a DSC heating rate of 10 Kelvin per minute, and the phase transition temperatures thus determined can be used when heating and cooling the sample to determine the temperatures for heat treatment.

Chromium and other elements can be added in order, for example, to improve electrical resistance or mechanical properties. Like most other elements, chromium reduces the two-phase region of the binary Fe-17Co alloy. As a result, the amount of elements to be added in addition to vanadium is preferably selected such that together with vanadium it produces an increase in the two-phase region compared to the binary FeCo alloy. In addition, impurities and elements that have a particularly strong stabilising affect on the austenite (e.g. nickel) must be kept as low as possible.

The following contents have proved preferable in achieving very good magnetic properties:

cobalt content of 5 wt %≤Co≤25 wt %, with contents of 10 wt %≤Co≤20 wt % being preferred and contents of 15 wt %≤Co≤20wt % being very particularly preferred;

vanadium content of 0.3 wt %≤V≤5,0 wt %, with contents of 1.0 wt %≤V≤3.0 wt % being preferred, and the following sum: 0.2 wt %≤Cr+Si+Al+Mn≤3.0 wt %.

The alloys according to the invention are almost carbon-free and contain at most 0.02 wt % carbon, preferably 0.01 wt % carbon. This maximum carbon content should be regarded as an unavoidable impurity.

In the alloys according to the invention calcium, beryllium and/or magnesium may be added in small amounts of up to 0.05 wt % only for deoxidisation and desulphurisation. Up to 0.05 wt % cerium or cerium Mischmetal can be added to achieve particularly good deoxidisation and desulphurisation.

The composition according to the invention allows a further improvement. Cobalt has a higher diffusion coefficient in the paramagnetic BCC phase than in the ferromagnetic BCC phase. As a result, by separating the two-phase region and the Curie temperature T_{c}, vanadium allows a further temperature range with high self diffusion, thereby allowing a larger BCC grain structure and thus better soft magnetic properties due to heat treatment in this range or cooling through this range. In addition, the separation of the two-phase region and the Curie temperature T_{c} means that during cooling both the passage through the two-phase BCC/FCC region and the transition to the region of the BCC-only phase take place entirely in the paramagnetic state. This also has a positive effect on soft magnetic properties.

In one embodiment, the measured density of the annealed alloy is more than 0.10% lower than the density calculated using the rule of three from the average atomic weight of the metallic elements of the alloy, the average atomic weight of the metallic elements of the corresponding binary FeCo alloy and the measured density of this annealed binary FeCo-alloy.

Owing to the heat treatment, the sulphur content in the finished alloy may be lower than that in the molten mass. For example, the upper limit of the sulphur content in the molten mass may be 0.025 per cent by weight, while in the finished soft magnetic alloy the upper limit is 0.015 per cent by weight.

In one embodiment, a laminated core comprising a plurality of stacked electrically insulated sheets of a soft magnetic alloy is provided. The soft magnetic alloy consists essentially of:

| | | |
|---|---|---|
| 5 wt % | ≤Co | ≤25 wt % |
| 0.3 wt % | ≤V | ≤5.0 wt % |
| 0 wt % | ≤Cr | ≤3.0 wt % |
| 0 wt % | ≤Si | ≤3.0 wt % |
| 0 wt % | ≤Mn | ≤3.0 wt % |
| 0 wt % | ≤Al | ≤3.0 wt % |
| 0 wt % | ≤Ta | ≤0.5 wt % |
| 0 wt % | ≤Ni | ≤0.5 wt % |
| 0 wt % | ≤Mo | ≤0.5 wt % |
| 0 wt % | ≤Cu | ≤0.2 wt % |
| 0 wt % | ≤Nb | ≤0.25 wt % |
| 0 wt % | ≤Ti | ≤0.05 wt % |
| 0 wt % | ≤Ce | ≤0.05 wt % |
| 0 wt % | ≤Ca | ≤0.05 wt % |
| 0 wt % | ≤Mg | ≤0.05 wt % |
| 0 wt % | ≤C | ≤0.02 wt % |
| 0 wt % | ≤Zr | ≤0.1 wt % |
| 0 wt % | ≤O | ≤0.025 wt % |
| 0 wt % | ≤S | ≤0.015 wt % |

residual iron, where Cr+Si+Al+Mn≤3.0 wt %, and up to 0.2 wt % of other impurities. The soft magnetic alloy has a maximum permeability μₘₐₓ≥10,000, an electrical resistance ρ≥0.28 μΩm, hysteresis losses P_{Hys}≤0.055 J/kg at an amplitude of 1,5 T, a coercive field strength H_{c} von ≤0.5 A/cm and an induction B≥1.95 T at 100 A/cm. The laminated core has a fill factor F≥90%, preferably >94%.

During the production of the alloy and the method according to the invention the two-phase region is crossed twice, causing two phase transformations. A phase transformation causes an increase in volume in the sheets that leads to a plastic to deformation of the sheets that can be observed in practice through the formation of a wavelike shape. As a result, the original flatness of the sheets is not maintained and the fill factor of the laminated core is reduced. However, the flatness of the sheets and the fill factor of the laminated core can be achieved if the heating rate and/or the annealing temperature are set according to the invention. It is also possible, where necessary, to further position an additional weight on the sheets during heat treatment in order to ensure the flatness of the sheets and to achieve the fill factor of the laminated core.

In one embodiment the soft magnetic alloy of the laminated core has a maximum permeability μₘₐₓ≥12,000, preferably μₘₐₓ≥17,000.

In one embodiment the soft magnetic alloy has hysteresis losses P_{Hys}≤0.05 J/kg and/or a coercive field strength H_{c} of 0.4 A/cm, preferably H_{c} of 0.3 A/cm, and/or an induction B≥2.00 T at 100 A/cm.

In one embodiment the composition of the soft magnetic alloy is defined in greater detail, wherein
10 wt %≤Co≤20 wt %, preferably 15 wt %≤Co≤20 wt %, or
0.5 wt %≤V≤4.0 wt %, preferably 1.0 wt %≤V≤3.0 wt %, preferably 1.3 wt %≤V≤2.7 wt %, or
0.1 wt %≤Cr≤2.0 wt %, preferably 0.2 wt %≤Cr≤1.0 wt %, preferably 0.3 wt %≤Cr≤0.7 wt %, or
0.1 wt %≤Si≤2.0 wt %, preferably 0.15 wt %≤Si≤1.0 wt %, preferably 0.2 wt %≤Si≤0.5 wt % and/or
where the sum is 0.1 wt %≤Cr+Si+Al+Mn≤1.5 wt %, preferably 0.2 wt %≤Cr+Si+Al+Mn≤0.6 wt %.

The laminated core may have a varying number of sheets depending on the application. For example, the laminated core may have at least two sheets, e.g. for actuators, or at least 50 or 100 sheets for rotors and stators. The sheets may have a thickness of 0.05 mm to 0.50 mm and the electrical insulation between adjacent sheets may have a thickness of 0.1 μm to 2.0 μm.

The laminated core according to one of the embodiments described here can be used in an electrical machine, e.g. as or in a stator and/or a rotor of an electric motor and/or a generator, and/or in a transformer and/or in an electromagnetic actuator.

In an alternative embodiment the heat treatment temperatures used in a method for the production of a soft magnetic alloy, in particular the temperature T₁ in the FCC phase region, are defined in greater detail, whereby the heating rate and the cooling rate are selected as described above. In this embodiment a preliminary product is provided that has a composition consisting essentially of:

| | | |
|---|---|---|
| 5 wt % | ≤Co | ≤25 wt % |
| 0.3 wt % | ≤V | ≤5.0 wt % |
| 0 wt % | ≤Cr | ≤3.0 wt % |
| 0 wt % | ≤Si | ≤3.0 wt % |
| 0 wt % | ≤Mn | ≤3.0 wt % |
| 0 wt % | ≤Al | ≤3.0 wt % |
| 0 wt % | ≤Ta | ≤0.5 wt % |
| 0 wt % | ≤Ni | ≤0.5 wt % |
| 0 wt % | ≤Mo | ≤0.5 wt % |
| 0 wt % | ≤Cu | ≤0.2 wt % |
| 0 wt % | ≤Nb | ≤0.25 wt % |
| 0 wt % | ≤Ti | ≤0.05 wt % |
| 0 wt % | ≤Ce | ≤0.05 wt % |
| 0 wt % | ≤Ca | ≤0.05 wt % |
| 0 wt % | ≤Mg | ≤0.05 wt % |
| 0 wt % | ≤C | ≤0.02 wt % |
| 0 wt % | ≤Zr | ≤0.1 wt % |
| 0 wt % | ≤O | ≤0.025 wt % |
| 0 wt % | ≤S | ≤0.015 wt % |

residual iron, where Cr+Si+Al+Mn≤3.0 wt %, and up to 0.2 wt % of other impurities due to melting, and that has a cold rolling texture or a fibre texture. Other impurities include, for example, B, P, N, W, Hf, Y, Re, Sc, Be and other lanthanides other than Ce.

The preliminary product has a phase transition from a BCC phase region to a mixed BCC/FCC region to an FCC phase region, as the temperature rises the phase transition between the BCC phase region and the mixed BCC/FCC region taking place at a first transition temperature T_{Ü1} and, as the temperature continues to rise, the transition between the mixed BCC/FCC region and the FCC phase region taking place at a second transition temperature T_{Ü2}, where T_{Ü2}>T_{Ü1} and the difference T_{Ü2}−T_{Ü1} is less than 45K, preferably less than 25K.

The preliminary product is subjected to the following heat treatment:
heating up the preliminary product to a temperature T₁, followed by
heat treating the preliminary product at temperature T₁ for a period t₁, followed by cooling from T₁ to room temperature.

Alternatively, the preliminary product is subjected to the following heat treatment:
heating up the preliminary product to a temperature T₁, followed by
heat treating the preliminary product at temperature T₁ for a period t₁, followed by
cooling the preliminary product to a temperature T₂, followed by
heat treating the preliminary product at temperature T₂ for a period t₂, followed by
cooling the preliminary product from T₂ to room temperature, where T₁>T₂.

In these two methods temperature T₁ is set such that T₁ is between T_{Ü2} and (T_{Ü2}+100° C.) and T₂ is below T_{Ü1}, where 700° C.≤T₂≤1050° C. and T₂<T₁. In further embodiments T₁ is between (T_{Ü2}+2° C.) and (T_{Ü2}+100° C.) or between (T_{Ü2}+5° C.) and (T_{Ü2}+100° C.).

In a further embodiment the degree of cold working is increased in order to achieve improved soft magnetic properties, in particular high induction B and low coercive field strength H. In this embodiment the heating rate and the cooling rate can be set as described above.

In this embodiment an ingot can be produced from a molten mass that is provided by vacuum induction melting, electroslag re-melting or vacuum arc re-melting, for example, the molten mass consisting essentially of:

| | | |
|---|---|---|
| 5 wt % | ≤Co | ≤25 wt % |
| 0.3 wt % | ≤V | ≤5.0 wt % |
| 0 wt % | ≤Cr | ≤3.0 wt % |
| 0 wt % | ≤Si | ≤3.0 wt % |
| 0 wt % | ≤Mn | ≤3.0 wt % |
| 0 wt % | ≤Al | ≤3.0 wt % |
| 0 wt % | ≤Ta | ≤0.5 wt % |
| 0 wt % | ≤Ni | ≤0.5 wt % |
| 0 wt % | ≤Mo | ≤0.5 wt % |
| 0 wt % | ≤Cu | ≤0.2 wt % |
| 0 wt % | ≤Nb | ≤0.25 wt % |
| 0 wt % | ≤Ti | ≤0.05 wt % |
| 0 wt % | ≤Ce | ≤0.05 wt % |
| 0 wt % | ≤Ca | ≤0.05 wt % |
| 0 wt % | ≤Mg | ≤0.05 wt % |
| 0 wt % | ≤C | ≤0.02 wt % |
| 0 wt % | ≤Zr | ≤0.1 wt % |
| 0 wt % | ≤O | ≤0.025 wt % |
| 0 wt % | ≤S | ≤0.015 wt % |

residual iron, where Cr+Si+Al+Mn≤3.0 wt %, and up to 0.2 wt % of other impurities.

The molten mass is cast, solidified to form an ingot of a soft magnetic alloy and the ingot is then mechanically deformed.

The ingot is mechanically deformed by means of hot rolling at temperatures between 900° C. and 1300° C. to form a billet, then mechanically deformed to form a hot strip of thickness D₁ and then mechanically deformed by means of cold working to form a strip of thickness D₂, the degree of cold deformation being >40%, preferably >80%, to preferably >95%, where 0.05 mm≤D₂≤1.0 mm and D₂<D₁, the strip having a cold rolling texture or a fibre texture.

As in the methods referred to above, the soft magnetic alloy of the strip has a phase transition from a BCC phase region to a mixed BCC/FCC region to an FCC phase region, as the temperature rises the phase transition between the BCC phase region and the mixed BCC/FCC region taking place at a first transition temperature T_{Ü1} and, as the temperature continues to rise, the transition between the mixed BCC/FCC region and the FCC phase region taking place at a second transition temperature T_{Ü2}, where T_{Ü2}>T_{Ü1} and the difference T_{Ü2}−T_{Ü1} is less than 45K, preferably less than 25K.

The strip is subjected to the following heat treatment:
heating up the preliminary product to a temperature T₁, followed by
heat treating the preliminary product at temperature T₁ for a period t₁, followed by cooling from T₁ to room temperature, or

subjected to the following heat treatment:
heating up the preliminary product to a temperature T₁, followed by
heat treating the preliminary product at temperature T₁ for a period t₁, followed by
cooling the preliminary product to a temperature T₂, followed by
heat treating the preliminary product at temperature T₂ for a period t₂, followed by
cooling the preliminary product from T₂ to room temperature, where T₁>T₂.

In this embodiment T₁ is above T_{Ü2} and T₂ is below T_{Ü1}, where 920° C.≤T₁<Tₘ, and 700° C.≤T₂≤1050° C., where T₂<T₁ and Tₘ is the solidus temperature.

A cooling rate of 10 to 50 K/h between T₁ and 900° C., for example, is advantageous in achieving good soft magnetic properties and can eliminate the need for separate subsequent annealing or maintenance at temperature T₂ for long periods.

### BRIEF DESCRIPTION OF THE DRAWINGS

Embodiments of the invention are described in greater detail below with reference to the drawings and the following examples.

FIG. 1 shows a schematic illustration of the heat treatment according to the invention.

FIG. 2 shows a graph of coercive field strength H_{c} plotted against cooling rate. FIG. 3 shows a graph of induction B at 20 A/cm plotted against cooling rate. FIG. 4 shows metallographic sections for determining the grain size in two examples.

FIG. 5 shows metallographic sections of an example (93/0505) containing Si after annealing in the γ-region.

FIG. 6 shows a graph of induction B₂₀ (B at H=20 A/cm) plotted against grain size.

FIG. 7 shows a graph of coercive field strength H_{c} plotted against grain size.

FIG. 8 shows a graph of remanence Bᵣ and B₂₀ (B at H=20 A/cm).

FIG. 9 shows a graph of coercive field strength H_{c} plotted against cold deformation.

FIG. 10 shows a graph of induction B (20 A/cm) plotted against cold deformation.

### DETAILED DESCRIPTION OF EXAMPLE EMBODIMENTS

According to the invention, a soft magnetic alloy is provided that has a composition that consists essentially of:

| | | |
|---|---|---|
| 5 wt % | ≤Co | ≤25 wt % |
| 0.3 wt % | ≤V | ≤5.0 wt % |
| 0 wt % | ≤Cr | ≤3.0 wt % |
| 0 wt % | ≤Si | ≤3.0 wt % |
| 0 wt % | ≤Mn | ≤3.0 wt % |
| 0 wt % | ≤Al | ≤3.0 wt % |
| 0 wt % | ≤Ta | ≤0.5 wt % |
| 0 wt % | ≤Ni | ≤0.5 wt % |
| 0 wt % | ≤Mo | ≤0.5 wt % |
| 0 wt % | ≤Cu | ≤0.2 wt % |
| 0 wt % | ≤Nb | ≤0.25 wt % |
| 0 wt % | ≤Ti | ≤0.05 wt % |
| 0 wt % | ≤Ce | ≤0.05 wt % |
| 0 wt % | ≤Ca | ≤0.05 wt % |
| 0 wt % | ≤Mg | ≤0.05 wt % |
| 0 wt % | ≤C | ≤0.02 wt % |
| 0 wt % | ≤Zr | ≤0.1 wt % |
| 0 wt % | ≤O | ≤0.025 wt % |
| 0 wt % | ≤S | ≤0.015 wt % |

residual iron, wherein Cr+Si+Al+Mn≤3.0 wt %, and up to 0.2 wt % of other impurities due to melting. The impurities may, for example, be one or more of the elements B, P, N, W, Hf, Y, Re, Sc, Be or other lanthanides other than Ce. In order to increase the electrical resistance, in addition to the alloy element vanadium, it is also possible to add one or more elements from the group Cr, Si, Al and Mn in an amount that satisfies the following sum:

0.05 wt % Cr+Si+Al+Mn≤3.0 wt %.

The alloy may be provided in the form of a preliminary product (precursor product) that has a cold rolling texture or a fibre texture. The preliminary product may be a strip or one or more sheets suitable for the production of a laminate core.

The soft magnetic alloy or the preliminary product has a phase transition from a BCC phase region (also referred to as the a-region) to a mixed BCC/FCC region (also known as the α+γ-region) to an FCC phase region (also known as the γ-region), as the temperature rises the phase transition between the BCC phase region and the mixed BCC/FCC region taking place at a first transition temperature T_{Ü1} and, as the temperature continues to rise, the transition between the mixed BCC/FCC region and the FCC phase region taking place at a second transition temperature T_{Ü2}, where T_{Ü2}>T_{Ü1} and the difference T_{Ü2}−T_{Ü1} is less than 45K, preferably less than 25K.

The alloy is preferably melted in vacuum induction furnaces, though it can also be processed by means of vacuum arc re-melting or electroslag re-melting. The molten mass first solidifies into an ingot, from which the oxide skin is removed, and is then forged or hot rolled at temperatures between 900° C. and 1300° C. Alternatively, the removal of the oxide skin can also take place on bars that have previously been forged or hot rolled. The desired dimensions can be achieved by hot working strips, billets or bars. Surface oxides can be removed from hot rolled stock by blasting, grinding or stripping. Alternatively, however, the desired final dimensions can also be achieved by cold working strips, bars or wires. In the case of cold rolled strips, a grinding process can be integrated to remove embedded oxides caused by the hot rolling process. If cold working leads to excessive solidification, one or more intermediate annealing processes may be carried out at temperatures between 400° C. and 1300° C. to alloy recovery and re-crystallisation. The thickness or diameter for intermediate annealing should be selected such that cold working of preferably >40%, particularly preferably cold working of >80% and of >95%, is achieved by the final thickness.

This is followed by heat treatment according to one of the embodiments of the invention. This heat treatment is also referred to as final magnetic annealing. Final annealing is preferably carried out in a clean, dry hydrogen atmosphere. Annealing in an insert gas or vacuum is also possible.

In one embodiment the preliminary product is heated to a temperature T₁, then heat treated at temperature T₁ for a period t₁ and then cooled from T₁ to room temperature. In an alternative embodiment the preliminary product is heated to a temperature T₁, then heat treated at temperature T₁ for a period t₁, then cooled to a temperature T₂, then heat treated at temperature T₂ for a period t₂, then cooled from T₂ to room temperature. Temperature T₁ is greater than temperature T₂ . In addition, T₁ is above T_{Ü2}, i.e. in the FCC phase region, T₂ is below T_{Ü1}, i.e. in the BCC phase region, and 920° C.≤T₁<Tₘ, where Tₘ is the solidus temperature, and 700° C.<T₂≤1050° C.

For both methods the heating rate over at least the temperature range from T_{Ü1} to T_{Ü2} is 1 K/h to 100 K/h, preferably 10 K/h to 50 K/h, and the cooling rate over at least the temperature range from T_{Ü2} to T_{Ü1} is 1 K/h to 100 K/h, preferably 10 K/h to 50 K/h.

is In one embodiment a laminated core comprising a plurality of sheets is produced from an alloy according to the invention. The following method is used. The soft magnetic alloy is provided in the form of a strip that is coated with an electrically insulating layer made, for example, of an oxide. The strip is cut to length and metal panels are produced. These metal panels are stacked and the stacked metal panels are annealed or heat treated in a bell furnace according to one of these embodiments. The sheets can then be oxidised.

Following heat treatment the sheets are stuck together, the coated sheets being stacked with an adhesive layer to form a laminate, and cleaned and a laminated core suitable for use in a rotor or stator is formed, e.g. by electrical discharge machining, from the laminate.

In one embodiment stacks of 50 or 100 sheets (210×140×0.15 mm³) are annealed. In almost all tests a ceramic (244×213×10 mm³) plate weighing approx. 2 kg was used as the flat base. Once cut to length, the sheets are annealed as described below to ensure the flatness of the sheets and to increase the fill factor in the finished laminated core. In particular, the heating rate and the cooling rate are set to avoid any plastic deformation of the originally flat sheets and thus to obtain adequate flatness during the heat treatment.

In some embodiments, in addition the heating and cooling rates set, a weight is placed on the stacked sheets or panels. The weight is varied, in most cases a solid NCT3 covering plate (1.4841) (270×150×20 mm³) weighing 6.5 kg being used. The self-weight of the stack of sheets was 1.7 kg (50 sheets) or 3.4 kg (100 sheets) depending on the stack height.

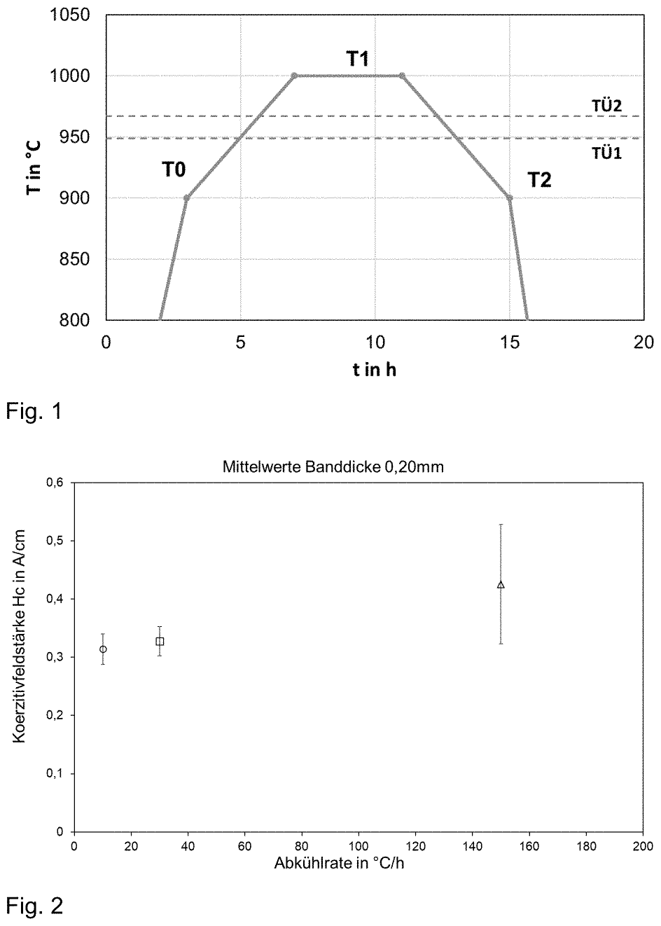

FIG. 1 shows a schematic curve for the test annealing processes. The broken lines indicate the expected range of the two-phase region. This two-phase region is dependent on the composition of the alloy.

The transition temperatures T_{Ü1} and T_{Ü2} for a given composition can be determined by means of DSC measurements. Table 1 shows the composition and transition temperatures for four examples.

TABLE 1

| | Co | V | Cr | Si | 1^{st} onset | Peak | 1^{st} onset | Peak | T_{c} Peak | T_{c} Peak |
|---|---|---|---|---|---|---|---|---|---|---|
| Batch 93/ | wt % | wt % | wt % | wt % | heating ( [symbol] ) | heating | cooling ( [symbol] ) | cooling | heating | cooling |
| 7604988 | 16.81 | 2.29 | 0.01 | 0.02 | 989 | 995 | 962 | 957 | 939 | 929 |
| 7605180 | 17.11 | 1.47 | 0.01 | 0.28 | 967 | 974 | 949 | 942 | 938 | 881 |
| 7605267 | 17.20 | 1.54 | 0.02 | 0.23 | 965 | 974 | 944 | 936 | 938 | 875 |
| 7409992 | 17.25 | 1.49 | 0.02 | 0.23 | 964 | 972 | 945 | 937 | 939 | 875 |

The annealing programme was selected such that the holding temperature Ti at 1000° C. to 1030° C. is above the two-phase region and in the FCC phase region, as shown in FIG. 1. According to DSC, in the batch used (7605180A) the FCC phase region is between 949° C. and 967° C. (1^{st} onset during cooling or heating). The passage through the two-phase region was varied, increasing from T₀ to T₁ during heating and from T₁ to T₃ during cooling, in each case with heating and cooling rates between 10 K/h and 100 K/h.

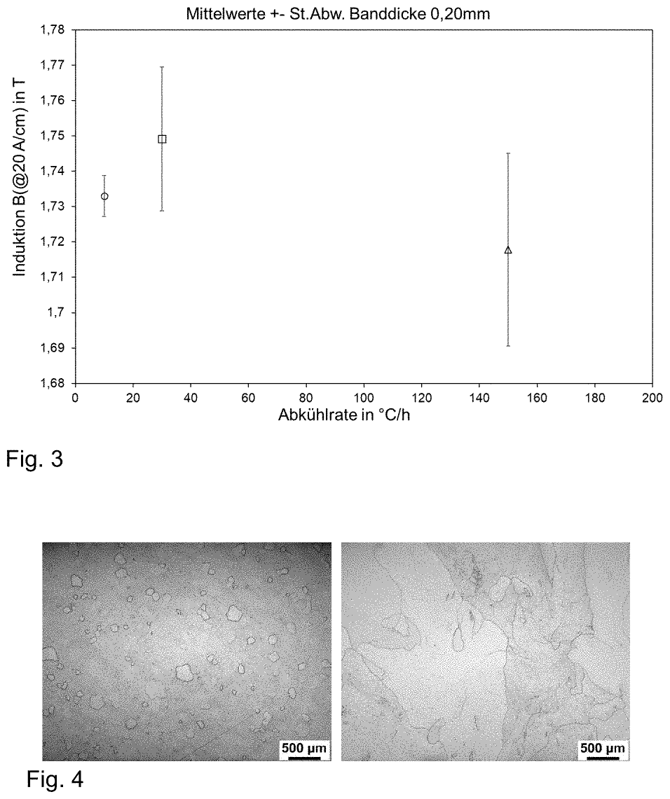

FIG. 2 shows a graph of coercive field strength H_{c} and FIG. 3 shows a graph of to induction B at H=20A/cm, both plotted against cooling rate.

Table 2 shows a summary of values for coercive field strength H_{c} and induction B at 20 A/cm and 100 A/cm for three examples that are heat treated at different heating rates and cooling rates. The induction values are similar in all cases, one advantage is of the slow heating and cooling rates lying in improved sheet flatness.

TABLE 2

| | | | | B | B | |
|---|---|---|---|---|---|---|
| | Heating | Holding | Cooling | (20 A/cm) | (100 A/cm) | H_{c} |
| # | rate | step | rate | in T | in T | in A/cm |
| 1 | from | 4 h | from | 1.706 | 2.009 | 0.432 |
| | 920° C. to | 1000° C. | 1000° C. to | | | |
| | 1000° C. at | | 920° C. at | | | |
| | 4 K/h | | 4 K/h | | | |
| 2 | from | 4 h | from | 1.717 | 1.984 | 0.378 |
| | 920° C. to | 1000° C. | 1000° C. to | | | |
| | 1000° C. at | | 920° C. at | | | |
| | 20 K/h | | 20 K/h | | | |
| 3 | from | 4 h | From | 1.722 | 1.987 | 0.433 |
| | 920° C. to | 1000° C. | 1000° C. to | | | |
| | 1000° C. at | | 920° C. at | | | |
| | 100 K/h | | 50 K/h | | | |

Batch 7605180A, strip thickness 0.20 mm

The measured coercive field strength is somewhat lower at slower cooling rates while the measured induction is somewhat higher at slower cooling rates. Consequently, it is possible to improve the soft magnetic properties of these alloys if cooling rates less than 100 K/h, preferably less than 50 K/h or less than 25 K/h, are used.

It has been found experimentally that heating or cooling sheets too quickly results in wavy sheets that also exhibit a type of plastic deformation within the sheets. When passing through the two-phase region, the body-centred α-phase (BCC) transforms into the more closely packed face-centred γse (FCC) as it is heated. This leads to a contraction of the sheets. A retransformation, during which the original geometry is ideally restored, then takes place during cooling. It can be assumed that the deformation observed is due to incomplete transformation and retransformation. The best results were achieved at heating and cooling rates of 20 K/h and 10 K/h. At higher rates, e.g. 50 K/h, slight waviness was observed with 50 sheets, and with 100 to sheets the sheets were unusable at rates of even 35 K/h.

It has been established that heating and cooling rate as well as weight can be set so as to obtain flat sheets. If no or only minimal weight is applied to the stack of sheets, significant waviness can occur. If annealing is carried out under the same conditions, is i.e. with the same low heating and cooling rates of 10 K/h, but with a solid weight of 6.5 kg, a completely flat stack of sheets is obtained. It is possible to separate all the sheets from one another without difficulty despite the heavy weight.

The results of the tests are summarised in Table 3, the following annealing evaluations being used:
Very good: the sheets are absolutely flat and exhibit no edge waviness
Good: the sheets are generally flat and exhibit minimal edge waviness
Poor: the sheets exhibit plastic deformation over at least half their surface
Very poor: the sheets show plastic deformation over their entire surface

TABLE 3

| | | | dT/dt | dT/dt | | | | |
|---|---|---|---|---|---|---|---|---|
| | Weight | | heating | cooling | | T₀ | T₁ = Tₘₐₓ | T₂ = T₀ |
| # Sheets | in kg | | in K/h | in K/h | Evaluation | in ° C. | in ° C. | in ° C. |
| 50 | 0 | none | 10 | 10 | Very poor | 900 | 1000 | 900 |
| 50 | 0.3 | 1) | 50 | 25 | Very poor | 930 | 1030 | 930 |
| 50 | 8.0 | 2) | 10 | 10 | Very good | 900 | 1000 | 900 |
| 50 | 6.5 | 3) | 50 | 50 | Good | 900 | 1000 | 900 |
| 50 | 6.5 | 3) | 50 | 25 | Good | 900 | 1000 | 900 |
| 50 | 6.5 | 3) | 100 | 25 | Poor | 900 | 1000 | 900 |
| 50 | 6.5 | 3) | 100 | 50 | Poor | 900 | 1000 | 900 |
| 100 | 6.5 | 3) | 20 | 20 | Very good | 920 | 1000 | 920 |
| 100 | 6.5 | 3) | 35 | 35 | Poor | 930 | 1000 | 930 |
| 100 | 6.5 | 3) | 100 | 50 | Very poor | 900 | 1000 | 900 |

1) Very low, uneven weighting with 4 small ceramic plates
2) Even weighting with 4 large ceramic plates of 2 kg each
3) Even weighting with 1 solid NCT3 plate weighing 6.5 kg

In one of the annealing tests (100 sheets, 20 K/h) a solid NCT3 plate was used as both the base and the weight. The sheets were of very good quality following annealing. These results show that the slow passage through the two-phase region is to conducive to the setting of good soft magnetic properties.

In a further group of examples the influence of the annealing temperature T₁, shown in FIG. 1, was investigated more closely. Table 4 shows the compositions of the examples.

It was found that the precise setting of the annealing temperature can be used to improve magnetic properties, in particular induction values. Grain size can also be set by setting the annealing temperature appropriately.

Annealing in the y-region was found to have a positive influence on induction values B20=B(20 A/cm), on coercive field strength Hₑ and on maximum permeability μₘₐₓ. An influence on the resulting grain size was also observed.

Here four compositions were tested in a strip thickness of 0.35 mm with different compositions, see Table 4. The contents of those elements not listed did not exceed 0.02 wt %.

TABLE 4

| | | Actual composition (wt %) | | | | |
|---|---|---|---|---|---|---|
| Batch | Nominal composition | Fe | Co | V | Cr | Si |
| 93/0328 | Fe-17Co-1,0V-1Cr | Residual | 17.08 | 0.98 | 1.04 | — |
| 93/0329 | Fe-17Cr-1.5V-0.5Cr | Residual | 17.12 | 1.46 | 0.54 | — |
| 93/0330 | Fe-17Co-2.0V | Residual | 17.19 | 1.97 | — | — |
| 93/0505 | Fe-17Co-1.4V-0.4Si | Residual | 16.97 | 1.39 | — | 0.40 |

These example have approx. 17% Co and additions of 1 to 2% V:
batches 93/0328 and 932/0329 also containing 0.5% to 1.0% Cr,
batch 93/0330 being a purely ternary Fe-Co-V without added Cr or Si, and
batch 93/0505 also having 0.4% Si in addition to Fe—Co—V.

The annealing processes were carried out at different temperatures in the range from 850° C. to 1150° C. The majority of the annealing processes took place at high is temperatures of at least 1000° C. in the γ-region, though some took place at lower temperatures in the α-region. The exact position of the two-phase region is indicated in Table 5. A large variation is apparent here, i.e. the upper phase limit α+γ→α is between 928° C., with the addition of significant Cr, and 970° C., with the addition of Si. The width of the two-phase region also varies strongly, ranging from 17° C. to 35° C.

Heating from 600° C. was typically carried out at 150 K/h. The cooling phase involved furnace cooling (approx. 100 to 150 K/h), an even slower cooling rate being expected at temperatures below 600° C.

TABLE 5

| | | α + γ→γ ¹⁾ | α + γ→α ²⁾ | Width α + γ |
|---|---|---|---|---|
| Batch | Nominal composition | in ° C. | in ° C. | in ° C. |
| 93/0328 | Fe-17Co-1.0V-1Cr | 893 | 928 | 35 |
| 93/0329 | Fe-17Cr-1.5V-0.5Cr | 925 | 945 | 20 |
| 93/0330 | Fe-17Co-2.0V | 950 | 973 | 23 |
| 93/0505 | Fe-17Co-1.4V-0.4Si | 953 | 970 | 17 |

¹⁾ 1st onset heating in DSC,
²⁾ 1st onset cooling in DSC

With both charges, the annealing processes in the a-region (850° C., 910° C.) resulted, as expected, in relatively low induction values B20 =B(20 A/cm) of less than 1.7 T, high H_{c} values greater than 0.6 A/cm and lower maximum permeabilities μₘₐₓ below 5100 (see Tables 6 and 7). Table 6 shows the magnetic values and grain sizes d_{K} for alloy 93/0328 with added Cr (Fe-17Co-1V-1Cr). Table 7 shows the magnetic values to and grain sizes for alloy 93/0329 with added Cr (Fe-17Co-1.5V-0.5Cr).

TABLE 6

| | | T_{Max} | B20 | B100 | H_{c} in | | Br | dₖ |
|---|---|---|---|---|---|---|---|---|
| 93/0328 | Annealing | in ° C. | in T | in T | A/cm | μmax | in T | in μm |
| α | 4 h 850° C. | 850 | 1.656 | 1.918 | 0.93 | 3890 | 0.95 | 63-76 |
| | 10 h 910° C. | 910 | 1.623 | 1.887 | 0.63 | 4902 | 1.02 | 107-125 |
| γ | 10 h 910° C. + | 930 | 1.771 | 2.036 | 0.47 | 6912 | 1.16 | >1500 |
| | 70 h 930° C. | | | | | | | |
| | 4 h 1000° C. | 1000 | 1.768 | 2.011 | 0.66 | 5130 | 1.16 | 210-430 |
| | 4 h 1050° C. | 1050 | 1.767 | 2.012 | 0.63 | 5387 | 1.18 | 180-350 |
| | 4 h 1100° C. | 1100 | 1.726 | 1.980 | 0.68 | 4958 | 1.10 | 210-350 |
| | 4 h 1150° C. | 1150 | 1.692 | 1.956 | 0.68 | 4863 | 1.09 | 180-350 |

B20 = B(20 A/cm), B100 = B(100 A/cm)

TABLE 7

| | | T_{Max} | B20 | B100 | Hc in | | Br | dₖ |
|---|---|---|---|---|---|---|---|---|
| 93/0329 | Annealing | in ° C. | in T | in T | A/cm | μmax | in T | in μm |
| α | 4 h 850° C. | 850 | 1.651 | 1.911 | 1.04 | 3584 | 0.88 | 75 |
| | 10 h 910° C. | 910 | 1.620 | 1.881 | 0.62 | 5090 | 1.13 | 151 |
| γ | 4 h 1000° C. | 1000 | 1.803 | 2.035 | 0.51 | 7929 | 1.38 | — |
| | (+10 h 910° C.) | | (1.807) | (2.038) | (0.38) | (16,658) | (1.53) | 250 |
| | 4 h 1050° C. | 1050 | 1.809 | 2.039 | 0.50 | 7943 | 1.39 | 302 |
| | 4 h 1100° C. | 1100 | 1.797 | 2.031 | 0.52 | 7497 | 1.35 | 214 |
| | 4 h 1150° C. | 1150 | 1.778 | 2.018 | 0.47 | 7860 | 1.35 | 254 |

B20 = B(20 A/cm), B100 = B(100 A/cm)

Annealing in the γ-region (up to 1050° C.) results in appreciably higher B20 values above 1.75 T. In the example with 1% Cr (Table 6) a further increase in annealing temperature (1100° C., 1150° C.) results in a clear drop in induction B20 by up to 80 mT compared to the best annealing at 930° C. In contrast, the example with 0.5% Cr (Table 7) is appreciably more stable in this respect, the drop in comparison to the to best annealing at 1050° C. being only approx. 30 mT.

FIG. 4 shows metallographic sections for determining grain size in batch 93/0328 (on the left: 10 h 910° C. (α), on the right: 10 h 910° C.+70 h 930° C. (γ)).

As far as grain size dₖ is concerned, the only finding for both batches is that annealing in the γ-region results in larger grains (>180 μm) than annealing in the α-region (<180 μm). Furthermore, no further relationship between B20 and grain size can be established since annealing batch 93/0328 at 1050° C. and 1150° C. leads to the same grain sizes of 180 μm to 350 μm but to very different B20 values of 1.767 T and 1.692 T.

However, the sample annealed for a very long time at 930° C. clearly reveals a relationship between coercive field strength H_{c} and grain size as both the lowest H_{c} in the batch (0.47 A/cm) and by far the largest grains (>1500 pm) occurred in this state.

In the ternary alloy 93/0330 with Fe-17Co-2V (Table 8) two annealing processes were carried out in the α-region (850° C., 910° C.) and four annealing processes were carried out in the γ-region (1000° C., 1050° C., 1100° C., 1150° C.) (cf. Table 8). It was also confirmed here that the increase in induction B20 does not occur until annealing to reaches the γ-region. In addition, this value falls again at very high annealing temperatures of 1100° C. or more.

TABLE 8

| | | T_{Max} | B20 | B100 | Hc in | | Br | dₖ |
|---|---|---|---|---|---|---|---|---|
| 93/0330 | Annealing | in ° C. | in T | in T | A/cm | μmax | in T | in μm |
| α | 4 h 850° C. | 850 | 1.648 | 1.906 | 1.05 | 3533 | 0.87 | — |
| | 10 h 910° C. | 910 | 1.615 | 1.873 | 0.68 | 4868 | 1.11 | — |
| γ | 4 h 1000° C. | 1000 | 1.801 | 2.038 | 0.41 | 10,618 | 1.44 | 300-350 |
| | 4 h 1050° C. | 1050 | 1.812 | 2.040 | 0.35 | 12,670 | 1.50 | 250-350 |
| | 4 h 1100° C. | 1100 | 1.786 | 2.028 | 0.38 | 10,051 | 1.41 | 300-430 |
| | 4 h 1150° C. | 1150 | 1.756 | 2.005 | 0.36 | 10,568 | 1.44 | 300-430 |

B20 = B(20 A/cm), B100 = B(100 A/cm)

In this batch it also becomes clear that remanence Br increases appreciably as a result of annealing in the γ-region, i.e. the loop becomes appreciably more rectangular (Br>1.4 T).

In example 93/0505 with added Si (Fe-17Co-1.5V-0.5Cr) only annealing in the γ-region was observed (1000° C., 1050° , 1100° C.). Table 9 shows the magnetic values and grain sizes for alloy 93/0505.

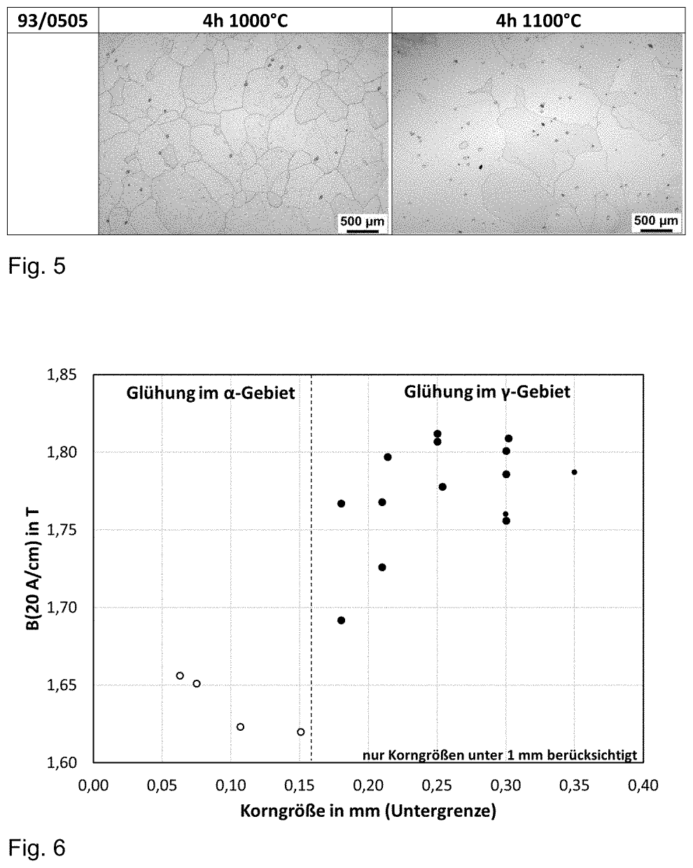

As for the other batches, very high B20 induction values of up to 1.79 T were measured, though they also fell again appreciably at 1100° C. The H_{c} values of approx. 0.3 A/cm, which are very low in comparison with the other compositions tested, and the very high permeability of greater than 10,000 can possibly be explained by the relatively large-grained structure (cf. Table 9 and FIG. 5).

TABLE 9

| | | T_{Max} | B20 | B100 | Hc in | | Br | dₖ |
|---|---|---|---|---|---|---|---|---|
| 93/0505 | Annealing | in ° C. | in T | in T | A/cm | μmax | in T | in μm |
| γ | 4 h 1000° C. | 1000 | 1.787 | 2.029 | 0.32 | 12,668 | 1.32 | 350-710 |
| | 4 h 1050° C. | 1050 | 1.760 | 2.020 | 0.26 | 14,272 | 1.24 | 300-360 |
| | 4 h 1100° C. | 1100 | 1.692 | 1.969 | 0.33 | 10,819 | 1.20 | Non- |
| | | | | | | | | homogenous, |
| | | | | | | | | up to >1500 |

B20 = B(20 A/cm), B100 = B(100 A/cm)

is In all the batches tested, the high induction values (B20>1.75 T) occurred only with annealing in the γ-region (FCC).

It was observed that after annealing the induction values were no more than just above the phase transition α+γ→γ (FCC+BCC→FCC). This correlates with a clear coarsening in structure.

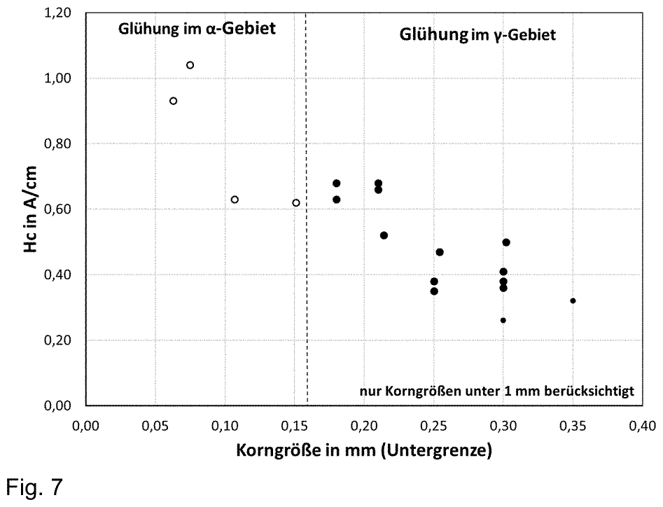

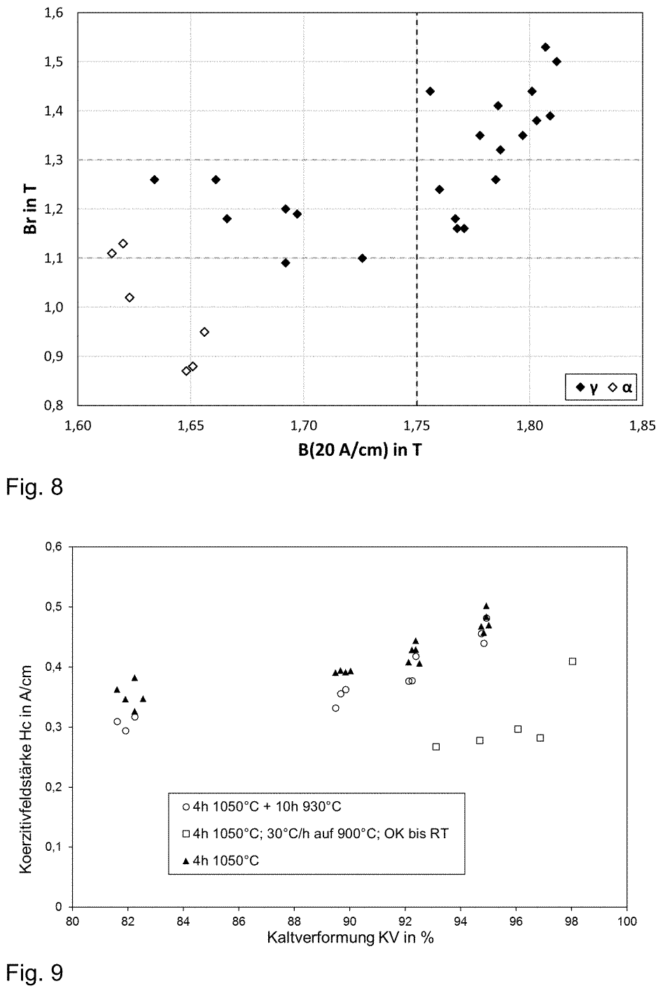

Table 10 shows a summary of the grain sizes measured in the batches tested taking into account all annealing processes with a duration of between 4 and 10 h. FIG. 6 shows a graph of induction B₂₀ (B at H=20 A/cm) plotted against grain size. FIG. 7 shows a graph of coercive field strength H_{c} plotted against grain size. FIG. 8 shows a relationship between remanence Bᵣ and B₂₀(B at H=20 A/cm) in all states tested. The solid symbols correspond to annealing in the γ-region (FCC), the hollow symbols to annealing in the α-region (BCC).

TABLE 10

| Grain sizes | | | | |
|---|---|---|---|---|
| after annealing | Annealing in the α-region | | Annealing in the γ-region | |
| (4-10 h) in μm | (BCC) | | (FCC) | |
| Batch | From | To | From | To |
| 93/0328 | 63 | 125 | 210 | 350 |
| 93/0329 | 75 | 151 | 214 | 302 |
| 93/0330 | — | — | 300 | 430 |
| 93/0505 | — | — | 300 | >1500 |

Increasing annealing temperature too much (to 1100° C. or higher) resulted in a fall in to the induction values observed. The four batches behaved differently, i.e. while batches 93/0329 and 93/0330 were still exhibiting very high B₂₀ values greater than 1.75 T at 1150° C., this value had already dropped to 1.69 T at 1150° C. and 1100° C. for batches 93/0328 and 93/0505. It proved impossible to detect any direct correlation between this effect and grain size.

Alloy 93/05050 with added Si shows appreciably larger grains than the compositions without Si. Accordingly, it also has the smallest Hₑ values, even the ternary Fe—Co—V molten mass from batch 93/0330 showing almost as high H_{c} values despite appreciably smaller grain size.

If one disregards states with very coarse grains of 1 mm or more, direct relationships between the magnetic characteristics and grain size emerge (cf. FIG. 4 (B₂₀) and FIG. 5 (H_{c})). Moreover, FIG. 6 shows that there is a link between high induction B20 and high remanence Bᵣ. Indeed, above a remanence of 1.3 T all states from this test show an induction B20 of at least 1.75 T auf. The increase in induction Is therefore associated with a breakdown of the hysteresis loop.

The influence of the degree of cold deformation on magnetic properties was examined in further embodiments. Low H_{c} and high B values proved advantageous in soft magnetic terms.

During rolling lateral expansion of the strip can be ignored and the degree of cold deformation KV of the final thickness D₂ is defined as the percentage reduction in thickness in relation to a non-cold-deformed initial thickness D₁. The following formula applies:

$$KV [ \% ] = \frac{{D}_{1} - {D}_{2}}{{D}_{1}} \cdot 100$$

The non-cold-deformed initial thickness D₁ may, for example, by produced by means of hot rolling or by intermediate annealing (ZGL). D₁ was varied within a range of 1.9 mm to 6.4 mm and D₂ was varied within a range of 0.35 mm to 0.10 mm. Three different heat treatments were used, annealing variants step 1+step 2 and step 1+controlled cooling. The cooling rate of the annealing process for 4 h at 1050° C. was 150° C./h. OK signifies furnace cooling, which also corresponds to a cooling rate of 150° C./h. RT signifies room temperature.

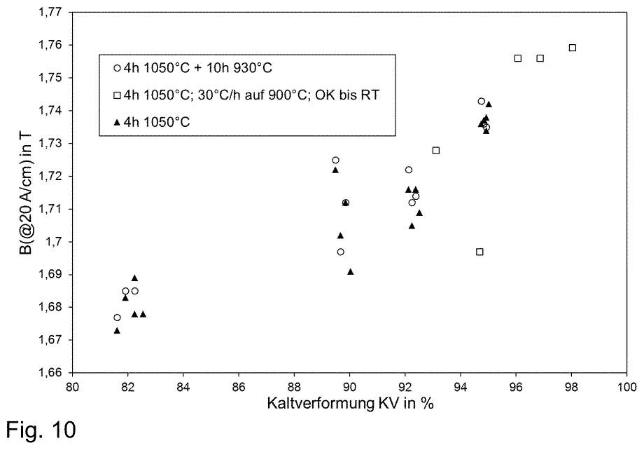

FIG. 9 shows a graph of coercive field strength H_{c} plotted against cold deformation. FIG. 10 shows a graph of induction B₂₀ (B at H=20 A/cm) plotted against cold deformation.

FIG. 9 indicates that induction B at a field strength H of 20 A/cm increases with cold deformation. The maximum cold deformation KV achieved is 98%. The B values can be improved by increasing cold deformation and it is possible to compensate for the deterioration of H_{c} as cold deformation increases by means of appropriate cooling after step 1 over the two-phase region.

In summary, a high permeability soft magnetic alloy is provided that both has better soft magnetic properties, e.g. appreciably higher permeability and lower hysteresis losses, and offers higher saturation than existing, commercially available FeCo alloys. At the same time, however, this new alloy also offers significantly lower hysteresis losses than previously known commercially available alloys with Co contents between 10 and 30 wt % and, above all, an appreciably higher level of permeability never previously achieved for this type of alloy. The alloy according to the invention can also be produced cost effectively on an industrial scale, particularly in the form of flat sheets and of a laminated core that may have a fill factor greater than 90% or 94% owing to the flat sheets.

1. A method for the production of a soft magnetic alloy comprising:
providing a preliminary product that has a composition consisting essentially of:

| | | |
|---|---|---|
| 5 wt % | ≤Co | ≤25 wt %, |
| 0.3 wt % | ≤V | ≤5.0 wt %, |
| 0 wt % | ≤Cr | ≤3.0 wt %, |
| 0 wt % | ≤Si | ≤3.0 wt %, |
| 0 wt % | ≤Mn | ≤3.0 wt %, |
| 0 wt % | ≤Al | ≤3.0 wt %, |
| 0 wt % | ≤Ta | ≤0.5 wt %, |
| 0 wt % | ≤Ni | ≤0.5 wt %, |
| 0 wt % | ≤Mo | ≤0.5 wt %, |
| 0 wt % | ≤Cu | ≤0.2 wt %, |
| 0 wt % | ≤Nb | ≤0.25 wt %, |
| 0 wt % | ≤Ti | ≤0.05 wt %, |
| 0 wt % | ≤Ce | ≤0.05 wt %, |
| 0 wt % | ≤Ca | ≤0.05 wt %, |
| 0 wt % | ≤Mg | ≤0.05 wt %, |
| 0 wt % | ≤C | ≤0.02 wt %, |
| 0 wt % | ≤Zr | ≤0.1 wt %, |
| 0 wt % | ≤O | ≤0.025 wt %, |
| 0 wt % | ≤S | ≤0.015 wt %, |

residual iron, wherein Cr+Si+Al+Mn≤3.0 wt %, and up to 0.2 wt % of other impurities due to melting,
the preliminary product having a cold rolling texture or a fiber texture, the preliminary product having a phase transition from a BCC phase region to a mixed BCC/FCC region to an FCC phase region, as the temperature rises the phase transition between the BCC phase region and the mixed BCC/FCC region taking place at a first transition temperature Tin and, as the temperature continues to rise, the transition between the mixed BCC/FCC region and the FCC phase region taking place at a second transition temperature T_{Ü2}, where T_{Ü2}>T_{Ü1} and the difference T_{Ü2}−T_{Ü1} is less than 45K,
wherein the preliminary product is subjected to the following heat treatment:
heating the preliminary product to a temperature T₁, followed by
heat treating the preliminary product at temperature T₁ for a period ti, followed by cooling from T₁ to room temperature,
or
wherein the preliminary product is subjected to the following heat treatment:
heating the preliminary product to a temperature T₁, followed by
heat treating the preliminary product at temperature T₁ for a period ti, followed by cooling the preliminary product to a temperature T₂, followed by
heat treating the preliminary product at temperature T₂ for a period t₂, followed by cooling the preliminary product from T₂ to room temperature,
wherein T₁>T₂, T₁≥T_{Ü2} and T₂≤T_{Ü1}, wherein 920° C.≤T₁>Tₘ, 700° C.≤T₂≤1050° C., and Tₘ is the solidus temperature.
wherein the heating rate over at least the temperature range from T_{Ü1} to T_{Ü1} is 1 K/h to 100 K/h, and
wherein the cooling rate over at least the temperature range from T_{Ü2} to T_{Ü1} is 1 K/h to 100 K/h.

2. A method according to claim 1, wherein the heating rate over at least the temperature range from 900° C. to T₁ is 1 K/h to 100 K/h.

3. A method according to claim 1, wherein the cooling rate over at least the temperature range from T₁ to 900° C. is 1 K/h to 100 K/h.

4. A method according to claim 1, wherein T₁ lies between T_{Ü2} and (T_{Ü2}+100° C.).

5. A method according to claim 1, wherein the preliminary product is weighted down by an additional weight and the preliminary product with the additional weight is subjected to the heat treatment.

6. A method according to claim 5, wherein the additional weight is at least 20% of the weight of the preliminary product.

7. A method according to claim 1, wherein the preliminary product has the form of a plurality of stacked sheets or one or more laminated cores.

8. A method according to claim 1, wherein the preliminary product has the form of a plurality of stacked sheets that are each coated with an electrically insulated coating.

9. A method according to claim 8, further comprising coating the preliminary product with an oxide layer for electrical insulation.

10. A method according to claim 9, wherein the preliminary product is coated with a layer of magnesium methylate or zirconium propylate that transforms into an insulating oxide layer during heat treatment.

11. A method according to claim 1, wherein following the heat treatment the preliminary product is subjected to further heat treatment in an atmosphere containing hydrogen or water vapor in order to form an electrically insulating layer.

12. A method according to claim 7, wherein following heat treatment at least one laminated core is produced from the stacked sheets by of electrical discharge machining, laser cutting or water jet cutting.

13. A method according to claim 12, wherein following heat treatment the plurality of sheets are:
stuck together by an insulating adhesive to form a laminated core, or
surface oxidised to form an insulating layer and then stuck or laser welded together to form a laminated core, or
coated with an inorganic-organic hybrid coating and then further processed to form a laminated core.

14. A method according to claim 1, wherein 960° C.≤T₁<Tₘ.

15. A method according to claim 1, wherein the preliminary product is heat treated for a period of over 15 minutes above T_{Ü2} and then cooled to T₂.

16. A method according to claim 1, wherein 15 minutes≤t₁≤20 hours.

17. A method according to claim 1, wherein 30 minutes≤t₂≤20 hours.

18. A method according to claim 1, wherein the preliminary product is cooled at least from T₁ to room temperature and then heated from room temperature to T₂.

19. A method according to claim 1, wherein following heat treatment the soft magnetic alloy has:
a maximum permeability μₘₐₓ≥5,000 and/or an electrical resistance ρ≥0.25 μΩm, hysteresis losses P_{Hys}≤0.07 J/kg at an amplitude of 1.5 T and/or a coercive field strength H_{c} of ≤0.7 A/cm and/or an induction B≥1.90 T at 100 A/cm, or
a maximum permeability μₘₐₓ≥10,000 and/or an electrical resistance ρ≥0.25 μΩm and/or hysteresis losses P_{Hys}≤0.06 J/kg at an amplitude of 1.5 T and/or a coercive field strength H_{c} of ≤0.6 A/cm and an induction B≥1.95 T at 100 A/cm, or
a maximum permeability μₘₐₓ≥12,000 and/or an electrical resistance ρ≥0.30 μΩm and/or hysteresis losses P_{Hys}≤0.05 J/kg at an amplitude of 1.5 T and/or a coercive field strength H_{c} of ≤0.5 A/cm and/or an induction B≥2.00 T at 100 A/cm.

20. A method according to claim 1, wherein the preliminary product is heat treated in a hydrogen-containing atmosphere or in an inert gas.

21. A method according to claim 1, further comprising:
providing by vacuum induction melting, electroslag re-melting or vacuum arc re-melting of a molten mass consisting essentially of:

| | | |
|---|---|---|
| 5 wt % | ≤Co | ≤25 wt %, |
| 0.3 wt % | ≤V | ≤5.0 wt %, |
| 0 wt % | ≤Cr | ≤3.0 wt %, |
| 0 wt % | ≤Si | ≤3.0 wt %, |
| 0 wt % | ≤Mn | ≤3.0 wt %, |
| 0 wt % | ≤Al | ≤3.0 wt %, |
| 0 wt % | ≤Ta | ≤0.5 wt %, |
| 0 wt % | ≤Ni | ≤0.5 wt %, |
| 0 wt % | ≤Mo | ≤0.5 wt %, |
| 0 wt % | ≤Cu | ≤0.2 wt %, |
| 0 wt % | ≤Nb | ≤0.25 wt %, |
| 0 wt % | ≤Ti | ≤0.05 wt %, |
| 0 wt % | ≤Ce | ≤0.05 wt %, |
| 0 wt % | ≤Ca | ≤0.05 wt %, |
| 0 wt % | ≤Mg | ≤0.05 wt %, |
| 0 wt % | ≤C | ≤0.02 wt %, |
| 0 wt % | ≤Zr | ≤0.1 wt %, |
| 0 wt % | ≤O | ≤0.025 wt %, |
| 0 wt % | ≤S | ≤0.015 wt %, |

residual iron, where Cr+Si+Al+Mn≤3.0 wt %, and up to 0.2 wt % of other impurities, solidifying the molten mass to form an ingot,
mechanically deforming the ingot to produce the preliminary product,
this mechanically deforming being carried out by means of hot rolling and/or forging and/or cold forming.

22. A method according to claim 21, wherein the ingot is mechanically deformed by hot rolling at temperatures of between 900° C. and 1300° C. to form a slab and then to form a hot strip of thickness D₁, then is mechanically deformed by cold rolling to form a strip of thickness D₂, where 0.05 mm≤D₂≤1.0 mm and D₂<D₁.

23. A method according to claim 23, wherein a hot strip of thickness D₁ is initially produced by continuous casting and then is mechanically deformed by cold rolling to form a strip of thickness D₂, where 0.05 mm≤D₂≤1.0 mm and D₂<D₁.

24. A method according to claim 22, wherein the degree of cold deformation by cold rolling is >40%.

25. A method according to claim 22, wherein the ingot is mechanically deformed by hot rolling at temperatures of between 900° C. and 1300° C. to form a billet and then mechanically deformed by cold drawing to form a wire.

26. A method according to claim 25, wherein the degree of cold deformation by cold drawing is >40%.

27. A method according to claim 1, wherein following heat treatment the average grain size is at least 100 μm, and the soft magnetic alloy having an induction B₁₀₀ (induction B at H=100 A.cm) of at least 1.90 T.

28. A laminated core comprising a plurality of electrically insulated sheets of a soft magnetic alloy that consists essentially of:

| | | |
|---|---|---|
| 5 wt % | ≤Co | ≤25 wt %, |
| 0.3 wt % | ≤V | ≤5.0 wt %, |
| 0 wt % | ≤Cr | ≤3.0 wt %, |
| 0 wt % | ≤Si | ≤3.0 wt %, |
| 0 wt % | ≤Mn | ≤3.0 wt %, |
| 0 wt % | ≤Al | ≤3.0 wt %, |
| 0 wt % | ≤Ta | ≤0.5 wt %, |
| 0 wt % | ≤Ni | ≤0.5 wt %, |
| 0 wt % | ≤Mo | ≤0.5 wt %, |
| 0 wt % | ≤Cu | ≤0.2 wt %, |
| 0 wt % | ≤Nb | ≤0.25 wt %, |
| 0 wt % | ≤Ti | ≤0.05 wt %, |
| 0 wt % | ≤Ce | ≤0.05 wt %, |
| 0 wt % | ≤Ca | ≤0.05 wt %, |
| 0 wt % | ≤Mg | ≤0.05 wt %, |
| 0 wt % | ≤C | ≤0.02 wt %, |
| 0 wt % | ≤Zr | ≤0.1 wt %, |
| 0 wt % | ≤O | ≤0.025 wt %, |
| 0 wt % | ≤S | ≤0.015 wt %, |

residual iron, wherein Cr+Si+Al+Mn≤3.0 wt %, and up to 0.2 wt % of other impurities, wherein the soft magnetic alloy has a maximum permeability μₘₐₓ≥10,000, an electrical resistance ρ≥0.28 μΩm, hysteresis losses P_{Hys}≤0.055 J/kg at an amplitude of 1.5 T, a coercive field strength H_{c} of ≤0.5 A/cm and an induction B≥1.95 T at 100 A/cm, and the laminated core has a fill factor F≥90%.

29. A laminated core according to claim 28, wherein the soft magnetic alloy has a maximum permeability μₘₐₓ≥12,000.

30. A laminated core according to claim 28, wherein the soft magnetic alloy has hysteresis losses P_{Hys}≤0.05 J/kg and/or a coercive field strength H_{c} of ≤0.4 A/cm and/or an induction B≥2.00 T at 100 A/cm.

31. A laminated core according to claim 28, wherein
10 wt %≤Co≤20 wt %, or
0.5 wt %≤V≤4,0 wt %, or
0.1 wt %≤Cr≤2.0 wt %, or
0.1 wt %≤Si≤2.0 wt %, and/or
the sum being 0.1 wt %≤Cr+Si+Al+Mn≤1.5 wt %.

32. A laminated core according to claim 28, wherein the laminated core has at least two sheets that each have a thickness of 0.05 mm to 0.50 mm, the electrical insulation between adjacent sheets having a thickness of 0.1 μm to 2.0 μm.

33. An electric machine comprising a laminated core according to claim 28.

34. A method for the production of a soft magnetic alloy, the method comprising:
providing a preliminary product having a composition consisting essentially of:

| | | |
|---|---|---|
| 5 wt % | ≤Co | ≤25 wt %, |
| 0.3 wt % | ≤V | ≤5.0 wt %, |
| 0 wt % | ≤Cr | ≤3.0 wt %, |
| 0 wt % | ≤Si | ≤3.0 wt %, |
| 0 wt % | ≤Mn | ≤3.0 wt %, |
| 0 wt % | ≤Al | ≤3.0 wt %, |
| 0 wt % | ≤Ta | ≤0.5 wt %, |
| 0 wt % | ≤Ni | ≤0.5 wt %, |
| 0 wt % | ≤Mo | ≤0.5 wt %, |
| 0 wt % | ≤Cu | ≤0.2 wt %, |
| 0 wt % | ≤Nb | ≤0.25 wt %, |
| 0 wt % | ≤Ti | ≤0.05 wt %, |
| 0 wt % | ≤Ce | ≤0.05 wt %, |
| 0 wt % | ≤Ca | ≤0.05 wt %, |
| 0 wt % | ≤Mg | ≤0.05 wt %, |
| 0 wt % | ≤C | ≤0.02 wt %, |
| 0 wt % | ≤Zr | ≤0.1 wt %, |
| 0 wt % | ≤O | ≤0.025 wt %, |
| 0 wt % | ≤S | ≤0.015 wt %, |

residual iron, wherein Cr+Si+Al+Mn≤3.0 wt %, and up to 0.2 wt % of other impurities due to melting, and
the preliminary product having a cold rolling texture or a fiber texture, wherein the preliminary product has a phase transition from a BCC phase region to a mixed BCC/FCC region to an FCC phase region, as the temperature rises the phase transition between the BCC phase region and the mixed BCC/FCC region taking place at a first transition temperature T_{Ü1} and, as the temperature continues to rise, the transition between the mixed BCC/FCC region and the FCC phase region taking place at a second transition temperature T_{Ü2}, where T_{Ü2}>T_{Ü1} and the difference T_{Ü2}−T_{Ü1} is less than 45K,
wherein the preliminary product is subjected to the following heat treatment:
heating up the preliminary product to a temperature T₁, followed by heat treating the preliminary product at temperature T₁ for a period t₁, followed by cooling from T₁ to room temperature, or
wherein the preliminary product is subjected to the following heat treatment:
heating up the preliminary product to a temperature T₁, followed by heat treating the preliminary product at temperature T₁ for a period ti, followed by
cooling the preliminary product to a temperature T₂, followed by heat treating the preliminary product at temperature T₂ for a period t₂, followed by cooling the preliminary product from T₂ to room temperature, wherein T₁>T₂,
wherein T₁ lies between T_{Ü2} and (T_{Ü2}+100° C.) and T₂ lies below T_{Ü1}, wherein 700° C.≤T₂≤1050° C. and T₂<T₁.

35. A method for the production of a soft magnetic alloy, comprising:
providing by vacuum induction melting, electroslag re-melting or vacuum are re-melting of a molten mass consisting essentially of:

| | | |
|---|---|---|
| 5 wt % | ≤Co | ≤25 wt %, |
| 0.3 wt % | ≤V | ≤5.0 wt %, |
| 0 wt % | ≤Cr | ≤3.0 wt %, |
| 0 wt % | ≤Si | ≤3.0 wt %, |
| 0 wt % | ≤Mn | ≤3.0 wt %, |
| 0 wt % | ≤Al | ≤3.0 wt %, |
| 0 wt % | ≤Ta | ≤0.5 wt %, |
| 0 wt % | ≤Ni | ≤0.5 wt %, |
| 0 wt % | ≤Mo | ≤0.5 wt %, |
| 0 wt % | ≤Cu | ≤0.2 wt %, |
| 0 wt % | ≤Nb | ≤0.25 wt %, |
| 0 wt % | ≤Ti | ≤0.05 wt %, |
| 0 wt % | ≤Ce | ≤0.05 wt %, |
| 0 wt % | ≤Ca | ≤0.05 wt %, |
| 0 wt % | ≤Mg | ≤0.05 wt %, |
| 0 wt % | ≤C | ≤0.02 wt %, |
| 0 wt % | ≤Zr | ≤0.1 wt %, |
| 0 wt % | ≤O | ≤0.025 wt %, |
| 0 wt % | ≤S | ≤0.015 wt %, |

residual iron, wherein Cr+Si+Al+Mn≤3.0 wt %, and up to 0.2 wt % of other impurities, solidifying the molten mass to form an ingot of a soft magnetic alloy, mechanically deforming the ingot,
wherein the ingot is mechanically deformed by hot rolling at temperatures between 900° C. and 1300° C. to form a billet, is then mechanically deformed to form a hot strip of thickness D₁ and then is mechanically deformed by cold working to form a strip of thickness D₂, the degree of cold deformation being >40%, where 0.05 mm≤D₂≤1.0 mm and D₂<D₁, wherein the strip has a cold rolling texture or a fibre texture,
wherein the soft magnetic alloy of the strip has a phase transition from a BCC phase region to a mixed BCC/FCC region to an FCC phase region, as the temperature rises the phase transition between the BCC phase region and the mixed BCC/FCC region taking place at a first transition temperature T_{Ü1} and, as the temperature continues to rise, the transition between the mixed BCC/FCC region and the FCC phase region taking place at a second transition temperature T_{Ü2}, where T_{Ü2}>T_{Ü1} and the difference T_{Ü2}−T_{Ü1} is less than 45K,
wherein the strip is subjected to the following heat treatment:
heating up the preliminary product to a temperature T₁, followed by heat treating the preliminary product at temperature T₁ for a period ti, followed by cooling from T₁ to room temperature,
or
wherein the strip is subjected to the following heat treatment:
heating up the preliminary product to a temperature T₁, followed by heat treating the preliminary product at temperature T₁ for a period t₁, followed by
cooling the preliminary product to a temperature T₂, followed by heat treating the preliminary product at temperature T₂ for a period t₂, followed by cooling the preliminary product from T₂ to room temperature, where T₁>T₂,
wherein T₁ lies above T_{Ü2} and T₂ lies below T_{Ü1}, where 920° C.≤T₁<Tₘ, 700° C.≤T₂≤1050° C., and Tₘ is the solidus temperature.
